(19) United States
(12) Patent Application Publication
(10) Pub. No.: US 2015/0025948 A1
(43) Pub. Date: Jan. 22, 2015

(54) Brand Aware Advertising Systems

(71) Applicant: YuMe, Inc., Redwood City, CA (US)

(72) Inventors: Ayyappan Sankaran, San Jose, CA (US); Frank Barbieri, San Francisco, CA (US); Jayant Kadambi, Palo Alto, CA (US); Halim Damerdji, Los Altos, CA (US)

(73) Assignee: YuMe, Inc., Redwood City, CA (US)

(21) Appl. No.: 13/946,954

(22) Filed: Jul. 19, 2013

(51) Int. Cl. G06Q 30/02

(52) U.S. Cl. CPC G06Q 30/0242
USPC 705/14.4

(57) ABSTRACT

An example brand aware advertising system includes: (a) an advertising server interface operative to receive an advertisement request from an advertisement requestor; (b) a brand affinity engine coupled to the advertising server interface and operative to develop a brand affinity list from the advertisement request; and (c) an advertisement matching engine operative to provide a result to the advertising server interface if there is a match with the brand affinity list which can then be provided to the advertisement requestor. An alternate example embodiment further includes a brand aware ad exchange server operative to receive the brand affinity list from the advertisement matching engine if there is no match and to provide a result to the advertising server which is one of an advertisement and a null.

### CROSS REFERENCE TO RELATED APPLICATIONS

This application is related to: U.S. Ser. No. 12/817,095, filed Jun. 16, 2010, entitled System, Method and Apparatus for Automated Resource Allocation among Multiple Resource Server Systems; U.S. Ser. No. 13/163,691, filed Jun. 18, 2011, entitled Quality Scoring System for Internet Advertising Loci; and U.S. Ser. No. 13/831,337, filed Mar. 14, 2013, entitled Method and System for Determining Changes in Brand Awareness after Exposure to On-line Advertisements; all of which are owned by the assignee of the present application, and all of which are incorporated herein by reference.

### BACKGROUND

Advertising is a common way for sellers of goods and/or services to increase brand awareness. With traditional advertising media, such as television and print media, an advertisement may be seen by a wide demographic audience. Generally, only a small percentage of the audience will have any interest in ultimately purchasing the goods or services. Also, with traditional media, there is typically a limited supply of space for advertisements. In the art, the amount of resources (e.g., physical space, time, etc.) available for advertising is sometimes referred to as “inventory.” Due to its scarcity, premium inventory for traditional advertising media can be quite expensive.

With the advent of the Internet and the World Wide Web (“web”) the opportunity for online advertising has increased dramatically. Since web technology can generate advertisement (called an “impression”) each time a web page (or other platform such as a smartphone, tablet computer, game unit, etc.) is accessed, and since multiple members can access web page content simultaneously, there is also an ever-increasing amount of inventory. This tends to make web advertising more cost-effective than many forms of advertising in traditional media.

Besides cost, web advertising has a number of additional advantages. For one, particular demographic groups can be targeted by the selection of an appropriate website (“publisher”). For another, interaction with a web advertisement can be used to determine viewer interest. Also, web advertising tends to be more flexible with the choice of timing and placement of ads.

Since there is a significant cost to placing advertisements, even over the Internet, advertisers are keenly interested in the effectiveness of their advertisements. In particular, advertisers are interested on whether the awareness of the brand of the product or service that they are selling has increased due to their investment in advertising, and by how much. In this way, advertisers can maximize their return on their advertising campaigns.

As a result of large surplus of inventory, there is competition by websites (“publishers”) for advertisers and entities that represent advertisers such as advertisement (“ad”) agencies, ad networks, etc. An advertiser desires to place its advertisements where they are most effective, typically through an advertisement server (“ad server”). Matching publishers with advertisers has been directly, to a great extent, handled by media buyers and media sellers (including intermediaries such as ad agencies), or in a more automated fashion through advertising exchanges.

An advertising exchange (“ad exchange”) server is, essentially, a real-time, automated clearinghouse for inventory of publishers. Typically a publisher will query the ad exchange server whether there is any interest in a given segment of its inventory at a reserve price. The ad exchange server also has advertisers (sometimes represented by ad agencies or other intermediaries) who bid on the inventory based upon their own targeting criteria. If there are no bids, the publisher may drop its reserve price. If there is a single bid over the reserve price, that bid wins, and if there are multiple bids over the reserve price, typically the highest bid wins. The ad exchange server then connects the winning advertiser to the publisher's ad server, which redirects to the winning advertiser's system for ad delivery.

A problem with traditional ad exchange servers is that it is a monetary based system designed to get the highest real-time price for the publisher, regardless of the effectiveness of the placement for the winning advertiser. Ad exchanges of the prior art were not brand aware and often made poor choices for the advertisers as to which publisher should display its ads. Advertisers, over time, will statistically determine the effectiveness of their ads placed through the ad exchange servers and will adjust their bidding behavior accordingly.

These and other limitations of the prior art will become apparent to those of skill in the art upon a reading of the following descriptions and a study of the several figures of the drawing.

### SUMMARY

A brand aware advertising exchange system, set forth by way of example and not limitation, includes a supply side platform (SSP), a demand side platform (DSP), and a brand aware ad exchange server coupled between the SSP and the DSP. In an example embodiment, the brand aware ad exchange server implements the process of (a) receiving, via the DSP, brand data for each of a plurality of advertisements offered for publication; (b) receiving, via the SSP, a request from a publisher for an advertisement of a specified brand type for publishing; and (c) providing, via the SSP, information concerning an advertisement of the specified brand type which was selected from the plurality of advertisements offered for publication.

In an embodiment, set forth by way of example and not limitation, a computer implemented brand aware advertising exchange process includes: (a) receiving, at a brand aware ad exchange server, brand data concerning a plurality of advertisements to be published; (b) receiving, at the brand aware ad exchange server, a ranked brand affinity list which will perform well with respect to a publisher ad request; and (c) matching the publisher ad request with an advertisement, selected from the plurality of advertisements, based upon the brand data and the ranked brand affinity list.

A computer implemented brand aware advertisement server process, set forth by way of example and not limitation, includes: (a) receiving, at a brand aware advertisement server, an advertising request from an advertisement requestor; (b) creating a brand affinity list for the advertising request; (c) determining if there is an advertisement from a campaign which is a match for the brand affinity list; and (d) providing the advertisement to the advertisement requestor if there is a match.

In an embodiment, set forth by way of example and not limitation, a brand aware advertising system includes: (a) an advertising server operative to receive an advertisement request from an advertisement requestor; (b) a brand affinity engine coupled to the advertising server and operative to develop a brand affinity list from the advertisement request; and (c) an advertisement matching engine operative to provide a result to the advertising server if there is a match with the brand affinity list; whereby the advertising server provides the result to the advertisement requestor. An alternate example embodiment further includes a brand aware ad exchange server operative to receive the brand affinity list from the advertisement matching engine if there is no match and to provide a result to the advertising server which is one of an advertisement and a null.

In an embodiment, set forth by way of example and not limitation, a brand aware advertisement exchange server includes a brand affinity engine and an ad matching engine. The brand affinity engine is responsive to a video ad request on behalf of a publisher and is operative to develop a ranked list of brand categories for the video ad request. The ad matching engine is responsive to the ranked list and is operative to provide a response consisting of one of a video ad and a null if no video ad is within any of the brand categories of the ranked list.

In an embodiment, set forth by way of example and not limitation a method for providing a brand aware advertisement exchange includes receiving, at a server, a request for a video ad campaign related to at least one brand category. Next, it is determined, on the server, whether there is at least one video ad campaign which fits within the at least one brand category. If so, an optimal video ad campaign is chosen.

An advantage of example embodiments is that the paradigm for selecting advertisements has shifted from a monetary basis (i.e. maximizing the profit for the publisher) to a brand building basis (i.e. providing the advertiser with the best publishing platform for their brand). This encourages advertisers to place their advertisements with the advertising exchange and encourages the publishers to improve the quality of their sites to attract the most advertisers.

These and other embodiments, features and advantages will become apparent to those of skill in the art upon a reading of the following descriptions and a study of the several figures of the drawing.

### BRIEF DESCRIPTION OF THE DRAWINGS

Several example embodiments will now be described with reference to the drawings, wherein like components are provided with like reference numerals. The example embodiments are intended to illustrate, but not to limit, the invention. The drawings include the following figures:

FIG. 1 illustrates an example system supporting features and embodiments set forth herein;

FIG. 2 is a block diagram of an example computer, computerized device, proxy and/or server which may form a part of the system of FIG. 1;

FIG. 3 is an illustration of a publisher interacting with a brand aware ad exchange server;

FIG. 4 is an illustration of a publisher interacting with one or more brand aware ad exchange servers through the intermediary of an ad server;

FIG. 5 is a block diagram of an example brand aware advertising exchange system;

FIG. 6 is a flow diagram of an example process operating on an example brand aware ad exchange server of FIG. 5;

FIG. 7 is a block diagram of an example brand aware advertising system;

FIG. 8 is a flow diagram of an example process operating on the example brand aware advertising system of FIG. 7;

FIG. 9 is a block diagram of an example brand aware ad exchange server; and

FIG. 10 is a flow diagram of an example process operating on the example brand aware ad exchange server of FIG. 9.

### DETAILED DESCRIPTION OF EXAMPLE EMBODIMENTS

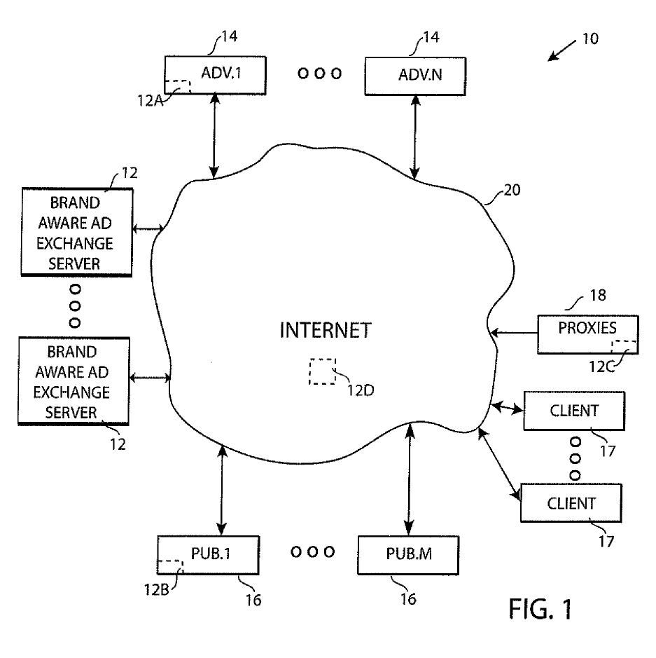

FIG. 1 illustrates a system 10 supporting brand aware advertising over the Internet in accordance with a non-limiting example. In this example, the system 10 includes one or more brand aware ad exchange servers 12, one or more advertiser servers 14, one or more publisher servers 16, and a plurality of client devices 17. The system at 10 may further include other computers, servers or computerized systems such as proxies 18. In this example, the brand aware ad exchange servers 12, advertiser servers 14, publisher servers 16, clients devices 17 and proxies 18 can communicate by a wide area network such as the Internet 20 (also known as a “global network” or a “wide area network” or “WAN” operating with TCP/IP packet protocols).

The brand aware ad exchange servers 12 can be implemented as a single server or as a number of servers, such as a server farm and/or virtual servers, as will be appreciated by those of skill in the art. Alternatively, the functionality of the brand aware ad exchange servers 12 may be implemented elsewhere in the system 10 such as on an advertiser server 14, as indicated at 12A, on the publisher server system 16, as indicated at 12B, on a proxy 18 as indicated at 12C or as part as cloud computing as indicated at 12D, all being non-limiting examples. As will be appreciated by those of skill in the art, the processes of brand aware ad exchange servers 12 can be distributed to various “platforms” or “engines” (a/k/a computerized devices and/or systems) within system 10.

As used herein, the term “publisher” refers to an entity or entities maintaining platforms which display advertisements (“ads”) to users. The term “advertiser” refers to an entity or entities which provide advertisements to publishers. For example, an “ad agency” or “ad network” is considered to be an advertiser because they provide advertisements to publishers on behalf of their clients.

It should be noted that the selection of publishers can be enhanced by categorizing the publishers by, for example, content. That is, a “publisher” can be a single legal entity, or a subset of that entity, or a part of a group of entities, by way of several non-limiting examples. For example, a publisher entity may have 1000 publications of which 100 are directed to dramatic content, 100 are directed to comedy, etc. The subset of publications of the publisher entity having a common thematic content may be considered a “publisher.” Furthermore, “publishers” may include a group of publications provided by different agencies which conform to a theme such as, by way of non-limiting examples, drama, sports or entertainment.

It should further be noted that, in some instances, an ad network is, essentially, transparent to advertisers, publishers or both. That is, an ad network may be considered to be a publisher or collection of publishers to an advertiser and/or an ad network may be considered to be an advertiser or collection of advertisers to a publisher. See, for example, System, Method and Apparatus for Automated Resource Allocation among Multiple Resource Server Systems, supra.

In an example, the brand aware ad exchange servers can provide middleman services between the advertisers and the publishers to facilitate the buying and selling of advertisements over the Internet. In other examples, the brand aware ad exchange server(s) provide middleman and/or facilitation services for client devices and resource servers to enhance a variety of e-commerce activities.

In the example of FIG. 1, the system 10 includes a plurality of advertiser servers 14 {ADV. 1, ADV. 2, . . . , ADV. N}. ADV. 1 can be, for example, a manufacturer of soft drinks, ADV. 2 can be a computer manufacturer and ADV. N can be, for example, an accounting firm. Alternatively, an advertiser can be an advertising agency acting as a middleman in the purchase of advertising for a client. While each of the advertising computers 14 may be implemented as a single computer, such as a personal computer or computer workstation, they can also represent other computer configurations, such as a computing cluster on a local area network (LAN).

The publisher servers 16 can each represent one or more servers, such as a server farm. In the example of FIG. 1, the system 10 includes a plurality of publisher servers 16 {PUB. 1, PUB. 2, . . . , PUB. M}. For example, PUB. 1 can be an Internet portal, PUB. 2 can be a search engine, and PUB. M can be a news website. As noted previously, one or more of the publisher servers 16 can implement some or all of the functionality of brand aware ad exchange servers 12.

Client devices 17 can access, for example, the publisher servers 16 via the Internet 20. Client devices can be of many types including personal computers, pc browsers, mobile devices, connected devices, tablet computers, set-top boxes, Blu-ray players, electronic game units, Internet access players, smart TV, IPTV, smart-phones, etc. A user of a client device 17 can, for example, visit a website hosted by a publisher server 16 using a web browser. Proxies 18 can be computers, servers, or clusters of servers which serve as intermediaries or proxies between the brand aware ad exchange servers, advertising computers and/or publisher servers 16. As noted previously, some or all of the functionality of brand aware ad exchange servers 12 may be implemented on proxies 18.

It will again be noted that the system 10 as illustrated in FIG. 1 is but one example of such a system. By way of non-limiting example, the advertiser servers 14 can be generalized to be virtually any form of computer or computerized device. By way of further non-limiting example, the publisher servers 16 can be generalized to be virtually any form of resource servers. It will therefore be appreciated that while certain example as described herein are directed to an e-commerce advertising sale and purchasing that there are other many other examples which can be implemented by the system 10 as described herein.

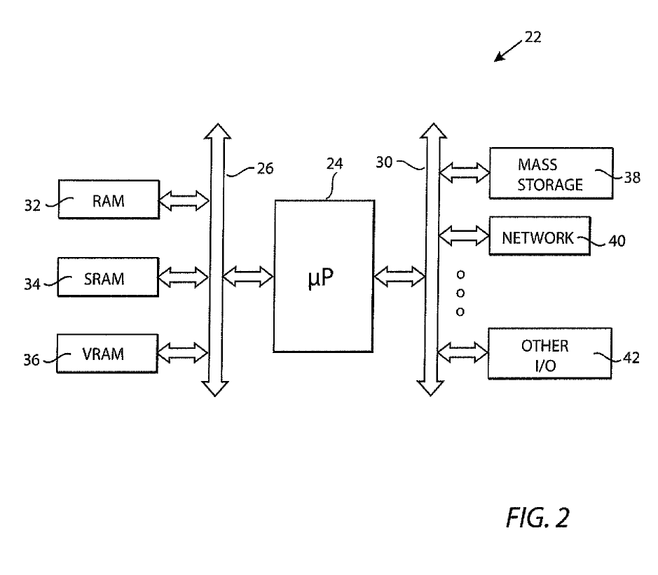

FIG. 2 is a simplified block diagram of a computer and/or server 22 suitable for use in system 10. Such computers and/or servers are available from a number of sources including Hewlett Packard Company of Palo Alto, California, Dell, Inc. of Austin Tex., Apple, Inc. of Cupertino, Calif., etc.

By way of non-limiting example, computer 22 includes a microprocessor 24 coupled to a memory bus 26 and an input/output (I/O) bus 30. A number of memory and/or other high speed devices may be coupled to memory bus 26 such as the RAM 32, SRAM 34 and VRAM 36. Attached to the I/O bus 30 are various I/O devices such as mass storage 38, network interface 40, and other I/O 42. As will be appreciated by those of skill in the art, there are a number of computer readable media available to the microprocessor 24 such as the RAM 32, SRAM 34, VRAM 36 and mass storage 38. The network interface 40 and other I/O 42 also may include computer readable media such as registers, caches, buffers, etc. Mass storage 38 can be of various types including hard disk drives, optical drives and flash drives, to name a few.

With respect to a client device 17 that is a computer or the like, the other I/O 42 typically includes a monitor, a keyboard, and a mouse (not shown). A client device 17 that is a computer includes an operating system, typically stored in mass storage 38 and one or more application programs running on the operating system. One such application program is a web browser available from a number of sources including Microsoft Corporation (Internet Explorer®), Google, Inc. (Chrome®), Apple, Inc. (Safari®) and Mozilla Foundation (Firefox®). Associated with those web browsers are “cookies”, which aid in the web browsing process. These application programs and cookies are also typically stored in mass storage 38.

It should be noted that many computerized devices may be within the scope of the system of FIG. 1. For example, many computerized devices, such as cellular telephones, smart phones, personal digital assistants (PDAs), network appliances, tablet computers, game units and other portable and non-portable devices can derive information, provide information, or otherwise interact with system 10. In many cases, these devices support electronic advertising. Typically, such devices include user identification (“ID”) numbers which allow a remote server to maintain log interactions with the computerized devices.

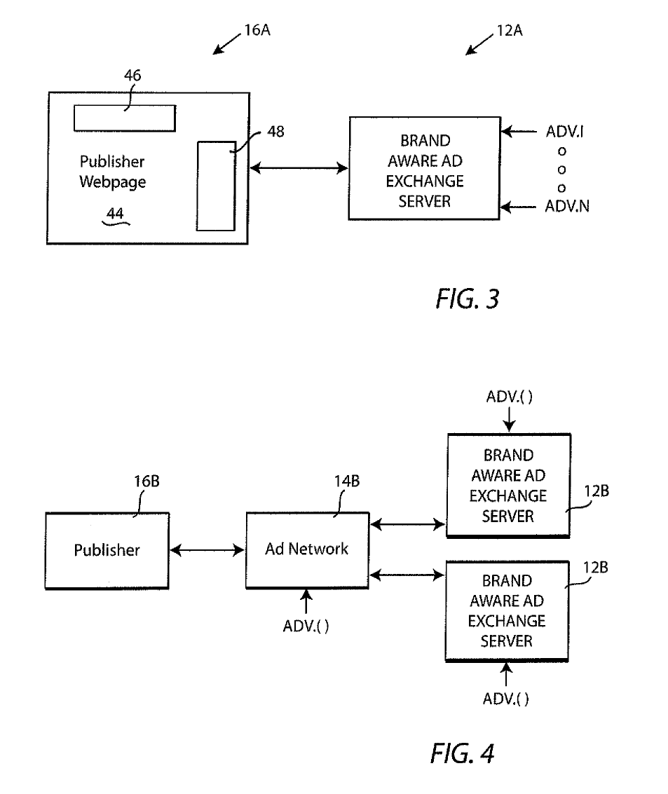

FIG. 3 is an illustration, set forth by way of example and not limitation, of a publisher 16A interacting with a brand aware ad exchange server 12A. In this non-limiting example, the publisher has a web page 44 having a first ad space or “leaderboard” 46 and a second ad space or “skyscraper” 48 which can support advertisements. The publisher 16A can send a message to brand aware ad exchange server 12A indicating that it wants a first brand type of advertisement for the leaderboard 46 and a second brand type of advertisement for skyscraper 48. For example, the first brand type might be a life insurance type advertisement, while the second brand type might be an electric car type advertisement. This message can be sent to the brand aware ad exchange server by, in a non-limiting example, an XML message.

Brand aware ad exchange server 12A is in communication with a number of advertisers ADV.1 to ADV. N which provide the brand aware ad exchange server 12A with brand data for a plurality of advertisements. For example, the brand data can include brand type such as “life insurance” and “electric car.” The brand aware server 12A can then provide information to the publisher 16A about which advertisement is the best fit for the specified brand type. If multiple ads are equally suitable for the specified brand type a selection can be made based upon what the advertisers are willing to pay for the publishing the ad, by random selection, or by other criteria.

FIG. 4 is an illustration, set forth by way of example and not limitation, of a publisher 16″ interacting with an ad network 14B which, in turn can interact with one or more brand aware ad exchange servers 12B. The ad network 14B and brand aware ad exchange servers 12B may also be interacting directly with one or more advertisers ADV( ). With the configuration of FIG. 4, the ad network 14B can provide the brand type data to the brand aware ad exchange servers 12B.

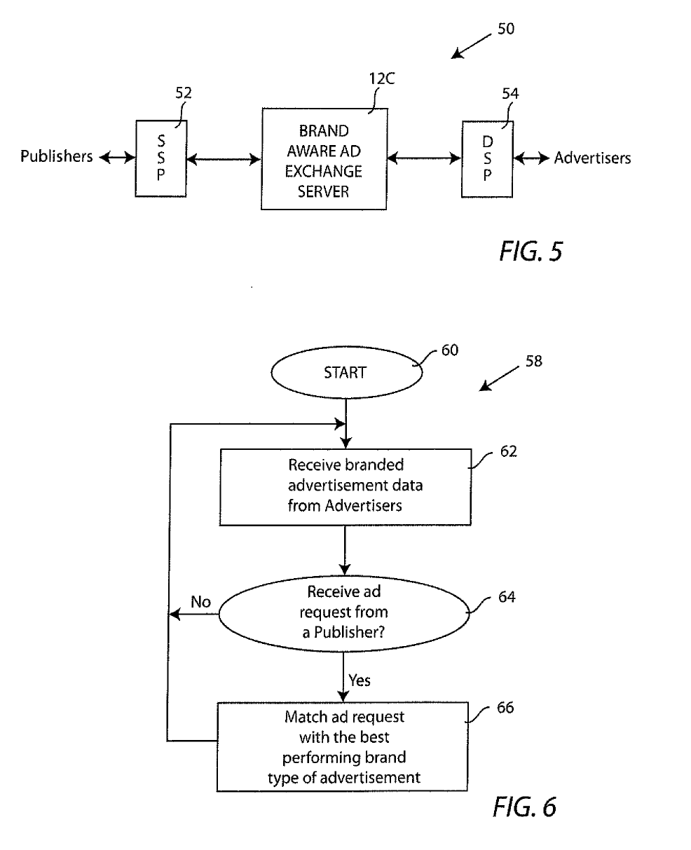

FIG. 5 is an illustration, set forth by way of example and not limitation, of a brand aware advertising exchange server system 50 including a supply side platform (SSP), a demand side platform (DSP), and a brand aware ad exchange server 12C coupled between the SSP 52 and the DSP 54. The brand aware ad exchange server 12C implements the process of (a) receiving, via the DSP 54, brand data for each of a plurality of advertisements offered for publication; (b) receiving, via the SSP 52, a request from a publisher for an advertisement of a specified brand type for publishing; and (c) providing, via the SSP 52, information concerning an advertisement of the specified brand type which was selected from the plurality of advertisements offered for publication.

FIG. 6 is a flow diagram, set forth by way of example and not limitation, of a process 58 operating on a brand aware advertising exchange such as brand aware ad exchange server 12C. The process 58 begins at 60 and, in an operation 62, branded advertisement data is received from advertisers. Next, in an operation 64, it is determined if an ad request is received from, or on behalf of, a publisher. If not, process control returns to operation 62. If an ad request has been received, an operation 66 matches the ad request with the best performing brand type of advertisement. Process control then returns to operation 62.

A quality scoring system for Internet advertising, set forth by way of example and not limitation, is disclosed in Quality Scoring System for Internet Advertising Loci, supra, which teaches, by way of example, the generation of a “quality score”, which is referred to therein as a Publisher Quality Score or “PQS.”

A method for developing a quality ranking of advertising loci (e.g. video advertisement locations in a display), set forth by way of example and not limitation, includes developing quality scores (e.g. PQS) for advertising loci and ranking the advertising loci based upon the quality scores. The ranked advertising loci can be used by publishers to improve the quality of their advertising loci and can be used by advertisers in their selection of advertising loci. PQS scores of publishers can also be used in the “brand aware” selection of ads for those publishers.

A video advertising scoring system for websites, web pages, and/or other Internet loci, set forth by way of example and not limitation, develops one or more advertising “quality scores” which are correlated to their “advertising quality.” The websites can be “ranked” by their quality scores to provide relevant information pertaining to video advertising decisions made with respect to the websites by, for example, advertisers, ad networks and publishers.

It should be noted that Publisher Quality Scores can be used advantageously by both advertisers and publishers. For example, advertisers can optimize their advertising budget by placing their advertisements where they will be the most effective. Publishers, on the other hand, can use quality scores to improve their attractiveness to advertisers. Implementing a brand aware advertisement exchange based upon quality scores, such as the example PQS quality scores, brings these benefits to the advertising exchange platform.

The value of the brand lift experienced by advertisers can be determined in a number of fashions. By way of non-limiting example, the brand lift can be calculated using on-line surveys. See, for example, Method and System for Determining Changes in Brand Awareness after Exposure to On-line Advertisements supra.

In an embodiment, set forth by way of example and not limitation, a method for determining changes in brand awareness after exposures to on-line advertisements includes: first selecting and monitoring a test group including a first plurality of members and a control group including a second plurality of members from a pool of users, whereby the first plurality of members and the second plurality of members do not overlap; second exposing the test group, but not the control group, to an advertisement associated with a brand; third conducting surveys of the first plurality of members and the second plurality of members with respect to the brand; and fourth analyzing the monitoring of the test group and the control group to determine a brand lift index with respect to the advertisement.

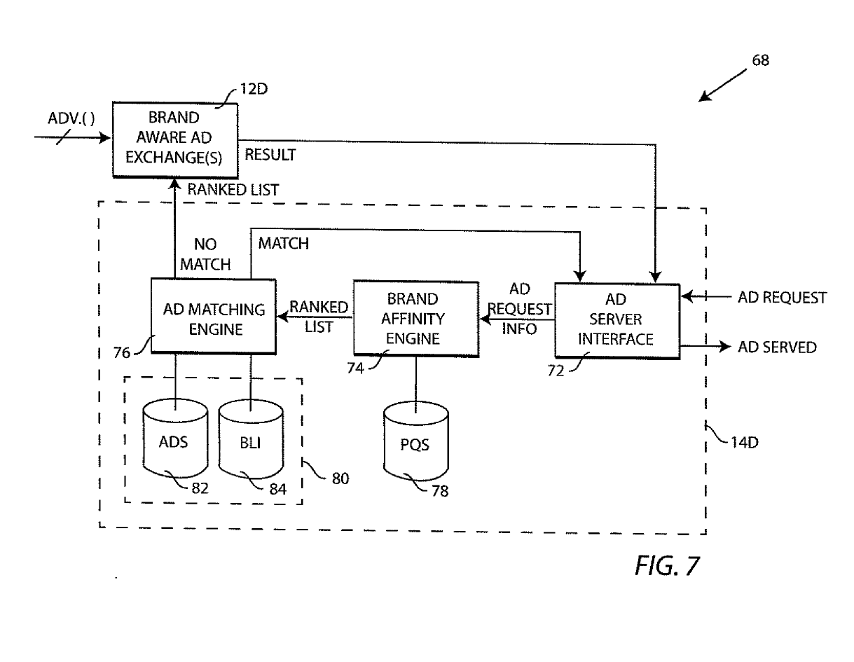

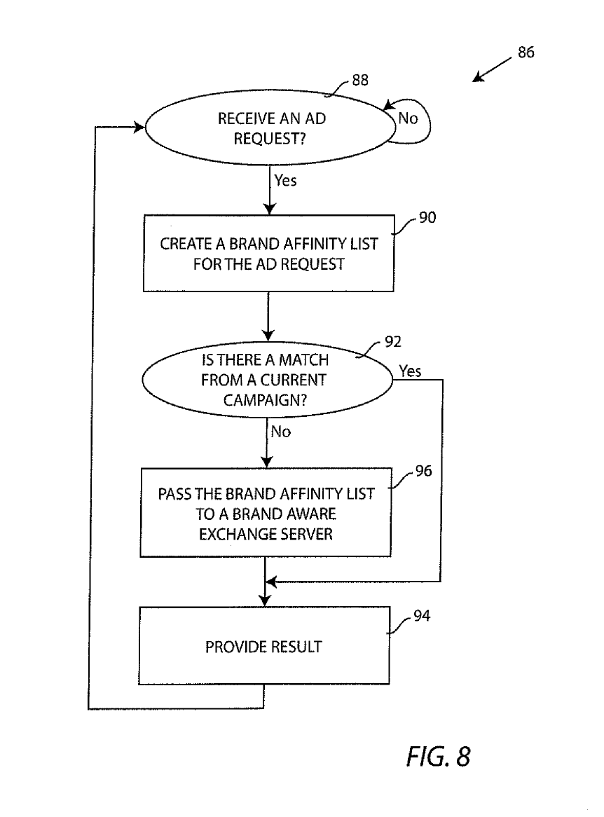

FIG. 7 is a block diagram of a brand aware advertising system 68 including, by way of non-limiting example, an advertiser server 14D and a brand aware ad exchange server 12D which can communicate with each other via a public network such as the Internet 20 (see, for example, FIG. 1). In other embodiments, the brand aware ad exchange server 12D is part of the advertiser server 14D and, in still further embodiments, some or all of the advertiser server 14D is public. Furthermore, parts or all of the functionality of the brand aware advertising system 68 can be integrated in one or more physical systems and may also be distributed, in whole or in part, over a network, such as the Internet.

In this non-limiting example, the advertiser server 14D includes an advertisement (“ad”) server interface 72, a brand affinity engine 74, and an advertisement (“ad”) matching engine 76. The ad server interface 72 receives advertisement (“ad”) requests from an advertising requestor (such a publisher or an intermediary of a publisher) and, if an appropriate advertisement is found, provides the advertisement (“ad served”) to the advertising requestor.

The brand affinity engine 74 receives information (“ad request info”) from the ad server interface 72 and may use a publisher performance database 78 to create a brand affinity list (“ranked list”) for the ad request. By way of non-limiting example, the publisher performance database can include Publisher Quality Score (“PQS”) information as described in Quality Scoring System for Internet Advertising Loci, supra. Using, for example, PQS information from the publisher performance database 78, it can be determined which brand categories will work the best for the ad request being serviced. For example, the brand affinity engine 74 might determine that the brand categories which work the best for the ad request being serviced are: 1) sports cars; 2) big screen televisions; and 3) golf clubs, in that order. As seen by this non-limiting example, the brand affinity engine 74 has created a ranked list of brand categories which will correspond to advertisements which would perform well with respect to the ad request.

The ad matching engine 76 is, in this non-limiting example, coupled to an advertisement information database 80 that includes advertising campaign information 82 and brand lift index (“BLI”) information 84. The advertising campaign information 82 includes a plurality of advertisements as well and information and metadata as to how the advertisements are to be placed with publishers. See, for example, System, Method and Apparatus for Automated Resource Allocation among Multiple Resource Server Systems, supra. The BLI information 84 includes information about the effectiveness of particular advertisements in the database. See, for example, Method and System for Determining Changes in Brand Awareness after Exposure to On-line Advertisement, supra.

The ad matching engine 76, in this non-limiting example, uses the ranked list obtained from the brand affinity engine 74 and the advertisement information database 80 to identify the advertisement that would perform the best with the ad request being serviced. For example, ad matching engine 76 can first seek to match advertisements for “sports cars” from its current advertising campaigns using advertising campaign information 82. If more than one advertisement is found, the BLI information 84 can be used to determine which of the advertisements in the category of “sports cars” would perform the best. This result or “match” is then provided to the ad server interface 72 and ultimately to the ad requester.

If, in the above example, no matching advertisement was found by ad matching engine 76 for “sports cars”, the ad matching engine 76 would then attempt to match an advertisement to the next best brand category of “big screen televisions.” If no matches were found for “big screen televisions”, attempts would be made with respect to remaining brand categories in the ranked list (e.g. “golf clubs” in this example).

It will be appreciated that the number of brand categories in the ranked list can be as few as one and as many as are suitable with respect to a given ad request. For example, if N brand categories rank very closely for an ad request, the ranked list can be N brand categories long. As another example, if only one brand category scores highly for a particular ad request, the ranked list might be only one brand category long, e.g. only “sports cars.”

If the ad matching engine 76 fails to make any matches, the ranked list may be provided to one or more brand aware ad exchange servers (“exchange(s)”) 12D. If the brand aware ad exchange server 12D is public, it may be accessed by advertisers ADV. ( ), publishers, and other third parties. In this non-limiting example where the brand aware ad exchange server 12D is public, the advertiser server 14D of this example may look like any other ad requestor. That is, in this example, the brand aware ad exchange server 12D would be provided with the ranked list by the ad matching engine 74 if it failed to match any advertisements with the ranked list and the result, if any, of the processes of brand aware ad exchange server 12D is provided to the ad server interface 72. The output of the brand aware ad exchange server 12D can be an advertisement or a “null”, indicating that no match was found. The ad server interface 72 then communicates with the ad requestor to either “serve up” the advertisement or to inform the ad requester that no suitable ad was available.

It should be noted that, in certain example embodiments, the brand aware ad exchange servers can be conventional exchange servers, where the ad matching engine 76 provides brand categories one at a time rather than as ranked list. For example, the ad matching engine could first request an advertisement for sports cars, then for big screen televisions if no advertisements for sports cars were available at the exchange server, etc. It should also be noted that the brand aware ad exchange server(s) 12D can implement the functionality of the advertiser server 14D if, for example, the BLI information 84 were available to it. Otherwise, a simple match to the raked list would provide suitable, if not optimal, results.

In FIG. 8, a flow diagram of a process 86, set forth by way of example and not limitation, operating on an example brand aware advertising system idles in an operation 88 which detects an incoming ad request from a publisher or other ad requestor. If an ad request is detected, an operation 90 creates a brand affinity list (“ranked list”) for the ad request and an operation 92 determines if there is a match from a current advertising campaign. If so, the result (e.g. a suitable advertisement) is provided to an ad requestor in an operation 94, and process control returns to operation 88. If operation 92 did not find a match, the brand affinity list is passed to a brand aware ad exchange server in an operation 96 which ultimately provides a result (e.g. either an advertisement or a “null”) to the ad requestor in operation 94 before process control returns to operation 88.

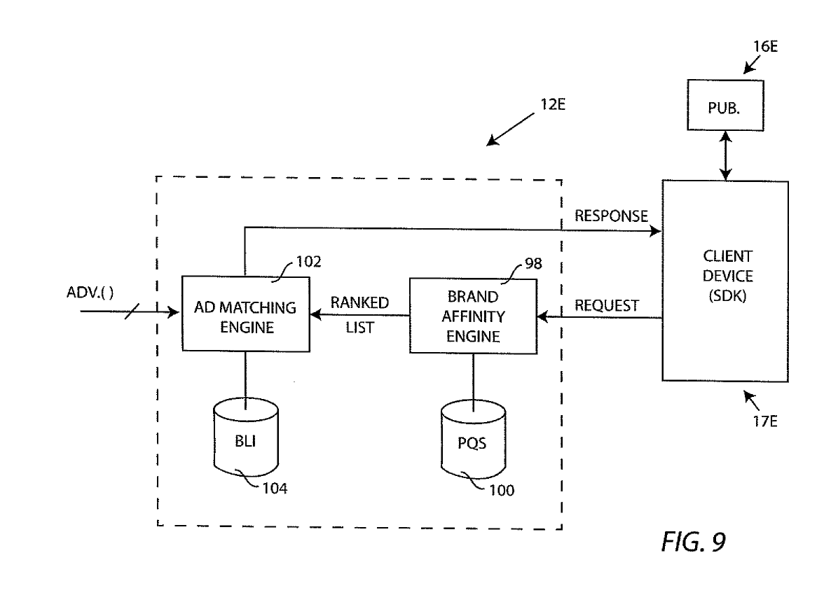

FIG. 9 is a block diagram of a brand aware ad exchange server 12E, set forth by way of example and not limitation, including a brand affinity engine 98 coupled to a PQS database 100 and an ad matching engine 102 coupled to a BLI database 104. The brand affinity engine 98, the PQS database 100, the ad matching engine 102, and the BLI database 104 can, in this non-limiting example, operate substantially as described above. The brand affinity engine 98 is operative to develop a ranked list which is input into the ad matching engine 102 along with a number of video ad campaigns by advertisers ADV.( ) The ad matching engine 102 provides a response, e.g. either a video advertisement to be played or a null if there is no video campaign that is available for the brand of the request.

The request, in this non-limiting example, may be made by a client device 17E, which may have a software developer kit (SDK) interface particularly adapted for brand aware ad exchange server 12E, on behalf of a publisher 16E. For example, a client device 17E may be configured to display a web page generated by a publisher 16E which has a window for a video advertisement. The SDK of the client device 17E generates the request, in this example, and the response (e.g. a streaming video advertisement) is returned to the client device 17E for display. Examples of client devices 17E include personal computers, pc browsers, mobile devices, connected devices, tablet computers, set-top boxes, Blu-ray players, electronic game units, Internet access players, smart TV, IPTV, smart-phones, etc.

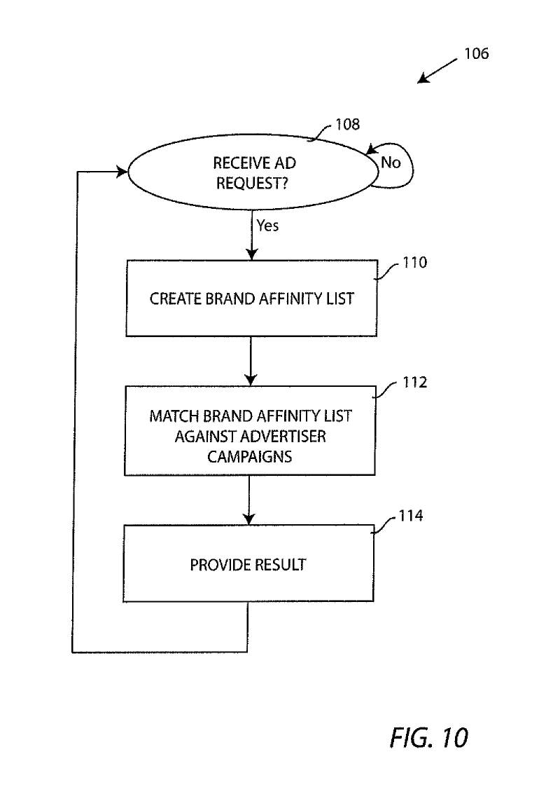

FIG. 10 is a flow diagram of an example process operating on the example brand aware ad exchange server of FIG. 9 and includes an operation 108 which determines if an ad request is received. If so, an operation 110 creates a brand affinity list as described previously. Next, in an operation 112, the brand affinity list is matched against a number of advertiser campaigns for the best match. Finally, in an operation 114, results are provided to the ad requestor (typically in the form of either a video advertisement or a null if no suitable video advertisement is found.

Although various embodiments have been described using specific terms and devices, such description is for illustrative purposes only. The words used are words of description rather than of limitation. It is to be understood that changes and variations may be made by those of ordinary skill in the art without departing from the spirit or the scope of various inventions supported by the written disclosure and the drawings. In addition, it should be understood that aspects of various other embodiments may be interchanged either in whole or in part.

What is claimed is:

1. A brand aware advertising exchange system comprising:
a supply side platform (SSP);
a demand side platform (DSP); and
a brand aware advertising (ad) exchange server coupled between the SSP and the DSP and implementing the processes of:
(a) receiving, via the DSP, brand data for each of a plurality of advertisements offered for publication;
(b) receiving, via the SSP, a request from a publisher for an advertisement of a specified brand type for publishing; and
(c) providing, via the SSP, information concerning an advertisement of the specified brand type which was selected from the plurality of advertisements offered for publication.

2. A brand aware advertising exchange system as recited in claim 1 wherein the SSP comprises a publisher server.

3. A brand aware advertising exchange system as recited in claim 1 wherein the DSP comprises an ad server.

4. A brand aware advertising exchange system as recited in claim 3 wherein the ad server comprises at least one of an ad network, an ad agency and an ad exchange.

5. A brand aware advertising exchange system as recited in claim 1 wherein the SSP couples the brand aware ad exchange server to a publisher server.

6. A brand aware advertising exchange system as recited in claim 1 wherein the DSP couples the brand aware ad exchange server to an advertiser server.

7. A brand aware advertising exchange system as recited in claim 6 wherein the ad server comprises at least one of an ad network, an ad agency and an ad exchange.

8-9. (canceled)

10. A brand aware advertising system comprising:
an advertising (ad) server interface operative to receive an ad request from an ad requestor;
a brand affinity engine coupled to the ad server interface and operative to develop a brand affinity list from the ad request; and
an ad matching engine operative to provide a result to the ad server interface if there is a match with the brand affinity list.

11. A brand aware advertising system as recited in claim 10 further comprising a brand aware advertisement (ad) exchange server operative to receive the brand affinity list from the ad matching engine if no suitable match is found by the advertisement matching engine.

12. A brand aware advertising system as recited in claim 10 wherein the result is an advertisement which is provided to the ad requestor.

13. A brand aware advertising system as recited in claim 12 further comprising a publisher performance database coupled to the brand affinity engine.

14. A brand aware advertising system as recited in claim 13 wherein the publisher performance database includes publisher quality score information.

15. A brand aware advertising system as recited in claim 14 wherein the brand affinity list comprises a ranked list of a plurality of brand categories which will perform well with respect to the ad request.

16. A brand aware advertising system as recited in claim 15 wherein the ad matching engine includes an ad information database.

17. A brand aware advertising system as recited in claim 16 wherein the ad information database includes advertising campaign information comprising a plurality of advertisements.

18. A brand aware advertising system as recited in claim 17 wherein the advertisement information database includes brand lift information.

19. A brand aware advertising system as recited in claim 17 wherein the advertisement matching campaign matches the brand lift information of the advertisements in the advertisement campaign database against the brand affinity list to determine which advertisement will perform the best with respect to the advertisement request.

20. A brand aware advertising system as recited in claim 19 wherein the ad server, the brand affinity engine and the ad matching engine comprise a advertiser server.

21. A brand aware advertising system as recited in claim 20 wherein the brand aware ad exchange server is part of the advertiser server.

22. A brand aware advertising system as recited in claim 20 wherein the brand aware ad exchange server is a brand aware ad exchange server which communicates with the advertiser server over the Internet.

23-25. (canceled)
